(19) United States
(12) Patent Application Publication
(10) Pub. No.: US 2018/0088818 A1
(43) Pub. Date: Mar. 29, 2018

(54) METHOD OF DATA BACKUP AND INFORMATION PROCESSING SYSTEM

(71) Applicant: FUJITSU LIMITED, Kawasaki-shi (JP)

(72) Inventors: Naomi Sakurai, Kanazawa (JP); Hirotaka Yamada, Kawasaki (JP); Satomi Tsutsui, Takaoka (JP); Yasutake Shiraki, Kanazawa (JP); Yasutaka Nagata, Kanazawa (JP); Hiroshi Ikuta, Kanazawa (JP)

(73) Assignee: FUJITSU LIMITED, Kawasaki-shi (JP)

(21) Appl. No.: 15/687,656

(22) Filed: Aug. 28, 2017

(30) Foreign Application Priority Data
Sep. 23, 2016 (JP) 2016-186325

(51) Int. Cl. G06F 3/06

(52) U.S. Cl. CPC G06F 3/065; G06F 3/0683; G06F 3/0619

(57) ABSTRACT

A method using a first information processing device, a second information processing device backing up first data of the first information processing device, and a third information processing device backing up second data of the second information processing device, the method includes storing, by the third information processing device, first information indicating that the second information processing device backs up the first data of the first information processing device, transmitting, from the third information processing device to the second information processing device, a first signal, and backing up, by the third information processing device, the first data of the first information processing device when the third information processing device does not receive, from the second information processing device, a first response signal that is a response to the first signal and indicates that the second information processing device transmits the second data to the third information processing device.

### CROSS-REFERENCE TO RELATED APPLICATION

This application is based upon and claims the benefit of priority of the prior Japanese Patent Application No. 2016-186325, filed on Sep. 23, 2016, the entire contents of which are incorporated herein by reference.

### FIELD

The embodiment discussed herein is related to a method of data backup and an information processing system.

### BACKGROUND

A blade server that includes a plurality of blades is known. Each of the blades is an information processing device (hereinafter referred to as “information processing unit” or merely referred to as “unit”) in which elements as a computer are mounted on a single board, while the blade server is a server in and from which a predetermined number of blades are able to be inserted and removed. In each of the blades inserted in the blade server, a processor, a volatile memory, a nonvolatile memory, an interface device, and the like are included. In addition, slots for blades are arranged on the side of an enclosure of the blade server, while a power supply device for supplying power to the blades and the like are included in the blade server. Each of the units holds, in a volatile memory or a nonvolatile memory, a computer program to be executed by a processor, data to be used for arithmetic processing by the processor, data that is the result of the arithmetic processing, log data related to the arithmetic processing, and the like. It is desirable that the data be backed up in preparation for failures of the units. For example, in a blade server including a first unit and a second unit, data of the first unit is backed up by the second unit, and data of the second unit is backed up by the first unit or another unit. In this specification, backup indicates a process of transmitting a copy of data stored in a memory of a certain unit to another unit and storing the copy of the data in a memory of the other unit.

The blade server may include a main control unit (MCU) for controlling the plurality of units. The MCU determines a mutual backup system or determines a unit that is among the plurality of units and will back up data of another unit among the plurality of units, and the MCU provides instructions to the units. In addition, when a certain blade is removed from the blade server or when a new blade is inserted in the blade server, the MCU instructs the units to newly reconfigure the mutual backup system. As related-art documents, there are Japanese Laid-open Patent Publications 07-334382 and 2003-316594.

### SUMMARY

According to an aspect of the invention, a method of data backup using an information processing system including a first information processing device, a second information processing device configured to back up first data of the first information processing device, and a third information processing device configured to back up second data of the second information processing device, the method includes storing, by the third information processing device, first information indicating that the second information processing device backs up the first data of the first information processing device, transmitting, from the third information processing device to the second information processing device, a first signal, and backing up, by the third information processing device, the first data of the first information processing device based on the first information when the third information processing device does not receive, from the second information processing device, a first response signal that is a response to the first signal and indicates that the second information processing device transmits the second data to the third information processing device.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a configuration diagram of an information processing device including a plurality of units;

FIG. 2 is a hardware configuration diagram of each of the units;

FIG. 3 is a diagram illustrating a mutual backup system of the plurality of units;

FIG. 4 is a functional block diagram of each of processors included in the units;

FIG. 5 is a diagram illustrating information registered in each of management tables;

FIG. 6 is a diagram illustrating a process of mutually transmitting and receiving backup data between the plurality of units;

FIG. 7 is a diagram illustrating the types of signals to be transmitted and received between the plurality of units and additional information included in the signals;

FIG. 8 is a diagram illustrating a process of updating, if any of the plurality of units fails, management tables by the other multiple units;

FIG. 9A is a flowchart of a process that is executed by a processor of a third unit in an example illustrated in FIG. 6 and is mainly related to the monitoring of a second unit;

FIG. 9B is a flowchart of a process that is executed by the processor of the third unit in the example illustrated in FIG. 8 upon the detection of a failure of the second unit;

FIG. 10 is a flowchart of a process that is executed by a processor of the second unit in the example illustrated in FIG. 6 and is mainly related to the transmission of a monitoring response signal and data;

FIG. 11 is a flowchart of a process that is executed by a process of a first unit in the example illustrated in FIG. 8 and is mainly related to a change in a management table;

FIG. 12A is a diagram illustrating coupling relationships between the plurality of units and power supply devices;

FIG. 12B is a diagram illustrating coupling relationships between the plurality of units and the power supply devices;

FIG. 13A is a diagram illustrating of a process of updating management tables by a plurality of units when a new unit is added;

FIG. 13B is a diagram illustrating the process of updating the management tables by the plurality of units when the new unit is added;

FIG. 14 is a diagram illustrating the types of signals to be transmitted between the plurality of units and additional information included in the signals;

FIG. 15 is a flowchart of a process that is executed by the processor of the second unit in an example illustrated in FIGS. 13A and 13B and is mainly related to the transmission of a data destination change request signal;

FIG. 16 is a flowchart of a process that is executed by the processor of the first unit in the example illustrated in FIGS. 13A and 13B and is mainly related to the reception of the data destination change request signal;

FIG. 17 is a flowchart of a process that is executed by the processor of the third unit in the example illustrated in FIGS. 13A and 13B and is mainly related to the transmission of a data destination change request signal;

FIG. 18 is a flowchart of a process that is executed by the processor of the second unit in the example illustrated in FIGS. 13A and 13B and is mainly related to the transmission of a data deletion request signal; and

FIG. 19 is a flowchart of a process that is executed by the processor of the third unit in the example illustrated in FIGS. 13A and 13B and is mainly related to the deletion of data.

### DESCRIPTION OF EMBODIMENT

In recent years, a blade server may not include an MCU and it is thus desirable that a mutual backup system be reconfigured even in a state in which control is not executed by an MCU. The present disclosure aims to provide an information processing system that includes a plurality of units and in which data is backed up mutually between the plurality of units and in which the plurality of units autonomously reconfigure a mutual backup system if a certain unit included in the information processing system fails or when the number of units included in the information processing system increases or is reduced.

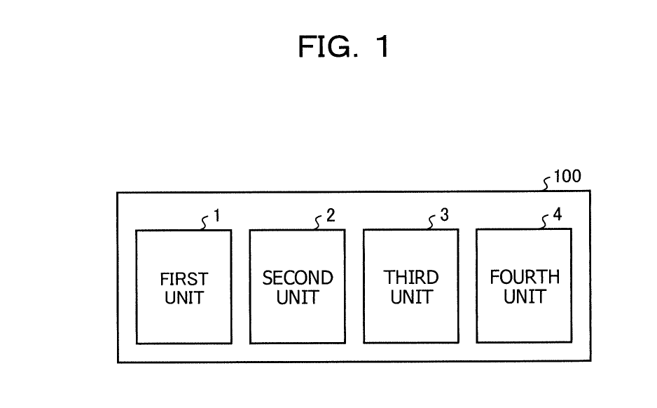

FIG. 1 is a configuration diagram of an information processing system including a plurality of units. The information processing system 100 includes a first unit 1, a second unit 2, a third unit 3, and a fourth unit 4. The number of the units included in the information processing system 100 is not limited to the number illustrated in FIG. 1. The information processing system 100 is, for example, a shelf blade server. However, the information processing system 100 to which an embodiment is applied is not limited to the blade server. The embodiment is applicable to a rack-mount server and an information processing system in which data is backed up mutually between multiple computers arranged in different enclosures.

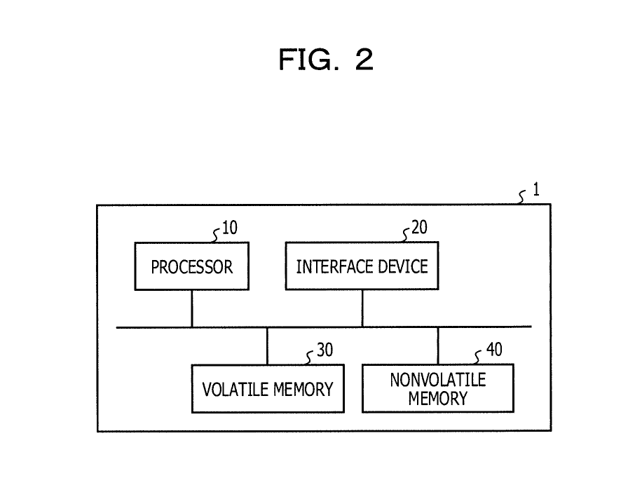

FIG. 2 is a hardware configuration diagram of each of the units. The units have hardware configurations that are substantially the same as or similar to each other. FIG. 2 illustrates the hardware configuration of the first unit 1. The first unit 1 includes a processor 10, an interface device 20, a volatile memory 30, and a nonvolatile memory 40. The processor 10 loads a computer program stored in the nonvolatile memory 40 into the volatile memory 30 and executes the computer program, thereby executing predetermined arithmetic processing. The processor 10 is a hardware processor. As the processor 10, a central processing unit (CPU), a micro control unit (MCU), a micro processing unit (MPU), a digital signal processor (DSP), a field programmable gate array (FPGA), or the like is applicable.

The interface device 20 functions as a communication interface with another unit. In the nonvolatile memory 40, the computer program to be executed by the processor 10 and the like are stored. The nonvolatile memory 40 is, for example, a read only memory (ROM), a mask read only memory (mask ROM), a programmable read only memory (PROM), a flash memory, a magnetoresistive random access memory (MRAM), a resistance random access memory (ReRAM), a ferroelectric random access memory (FeRAM), or the like. In the volatile memory 30, the computer program stored in the nonvolatile memory 40 is loaded. In addition, in the volatile memory 30, data to be used for the arithmetic processing by the processor 10, data that is the result of the arithmetic processing, log data indicating a history record of the arithmetic processing, and the like are held. The volatile memory 30 is, for example, a static random access memory (SRAM), a dynamic random access memory (DRAM), or the like.

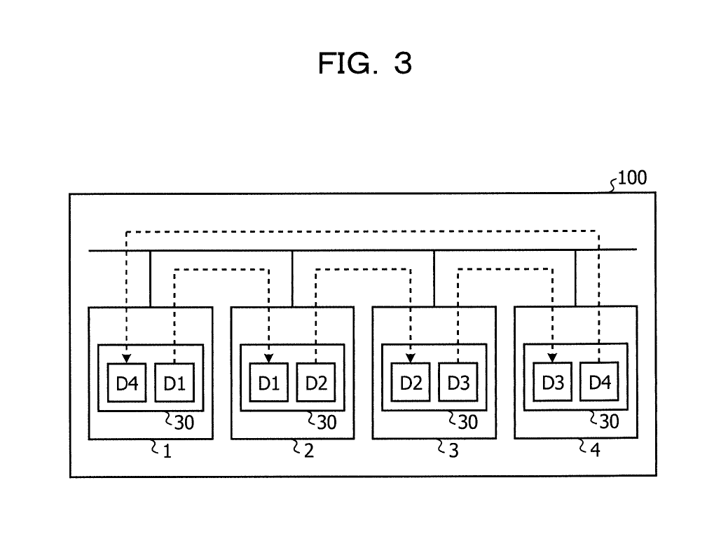

FIG. 3 is a diagram illustrating a mutual backup system of the plurality of units. In FIG. 3, data stored in the volatile memory 30 of the first unit 1 and to be backed up is indicated by “D1”. Data stored in the second unit 2 and to be backed up, data stored in the third unit 3 and to be backed up, and data stored in the fourth unit 4 and to be backed up are indicated by “D2”, “D3”, and “D4”, respectively.

In addition, the second unit 2 monitors whether or not the first unit 1 has failed (hereinafter, a “failure” of a unit includes the removal of the unit from the information processing system 100). The first unit 1 holds the data D1 in the volatile memory 30 of the first unit 1 and transmits the data D1 to the second unit 2. The second unit 2 receives the data D1 from the first unit 1 and holds the data D1 in the volatile memory 30 of the second unit 2. In a case where the data D1 of the first unit 1 is backed up by the second unit 2, the first unit 1 is referred to as a “monitoring target unit” of the second unit 2 and the second unit 2 is referred to as a “data destination unit” of the first unit 1. In FIG. 3, the first unit 1 monitors the fourth unit 4, the fourth unit 4 transmits the data D4 to the first unit 1, the third unit 3 monitors the second unit 2, the second unit 2 transmits the data D2 to the third unit 3, the fourth unit 4 monitors the third unit 3, and the third unit 3 transmits the data D3 to the fourth unit 4. In this manner, in the embodiment, the plurality of units mutually execute the monitoring and the data transmission in a ring.

The monitoring and the data transmission that are executed in the ring do not indicate that the plurality of units are arranged in a ring in physical arrangement relationship or are coupled in a ring in physical coupling relationship. The monitoring and the data transmission that are executed in the ring indicate that mutual relationships between the units that execute the monitoring and the data transmission are established in the ring in a logical manner.

All the data held in the units may not be transmitted to the data destination units as data to be backed up. For example, only log data held in the volatile memories 30 of the units and to be used to analyze causes of errors if the errors occur in arithmetic processing by the units may be transmitted to the data destination units as data to be backed up and may be backed up by the data destination units.

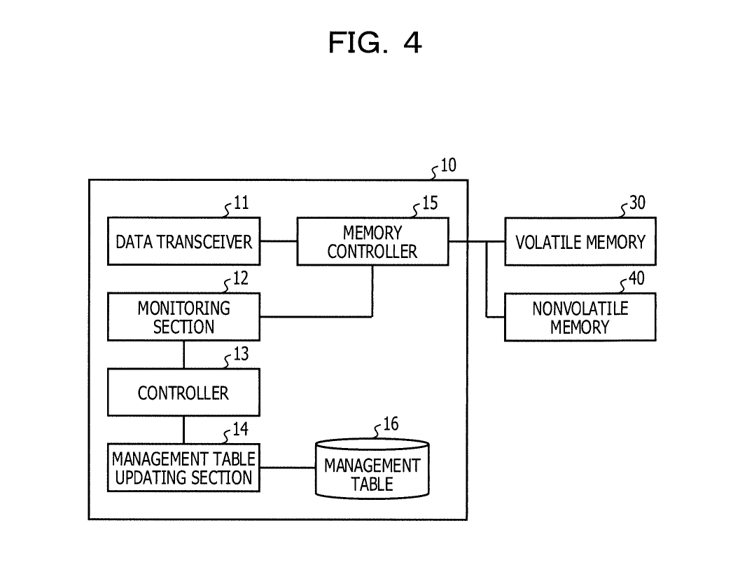

FIG. 4 is a functional block diagram of each of processors 10 included in the units. Each of the units include functional blocks, while functional blocks of each of the units are substantially the same as or similar to those included in the other units. FIG. 4 illustrates functional blocks of the processor 10 of the first unit 1. For example, the processor 10 loads the computer program stored in the nonvolatile memory 40 into the volatile memory 30 and executes the computer program, thereby functioning as a data transceiver 11, a monitoring section 12, a controller 13, a management table updating section 14, a memory controller 15, and a management table 16. The data transceiver 11 transmits backup data to a data destination unit and receives backup data from a monitoring target unit. The monitoring section 12 detects whether or not the monitoring target unit has failed. The controller 13 communicates with the monitoring target unit and the data destination unit. In addition, if a failure of the monitoring target unit has been detected, the controller 13 communicates with a newly set monitoring target unit and the data destination unit. When the monitoring target unit, the data destination unit, or a unit (monitoring target unit of the monitoring target unit) monitored by the monitoring target unit is changed, the management table updating section 14 executes a process of updating the management table 16. The memory controller 15 controls writing and reading of data in and from the volatile memory 30 and the nonvolatile memory 40. For example, when backup data transmitted from the monitoring target unit is received by the data transceiver 11, the memory controller 15 causes the received backup data to be stored in the volatile memory 30. In addition, the memory controller 15 reads, from the volatile memory 30, data stored in the unit and to be backed up and transmits the data to the data destination unit via the data transceiver 11.

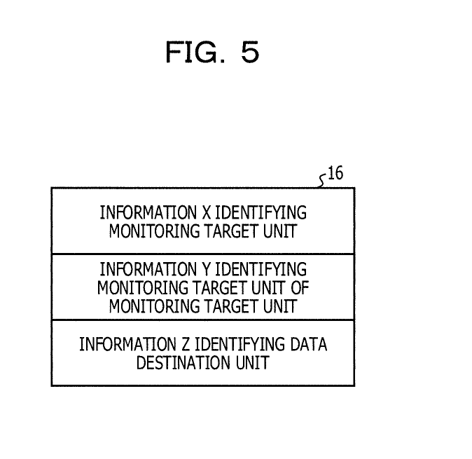

FIG. 5 is a diagram illustrating information registered in each of the management tables 16. In the management tables 16, information identifying monitoring target units of the plurality of units is registered. In this specification, the information identifying the monitoring target units is indicated by “X”. In the example illustrated in FIG. 3, the monitoring target unit of the second unit 2 is the first unit 1, and information indicating the first unit 1, for example, the identification (ID) of the first unit 1 is registered in the management table 16 of the second unit 2.

In addition, in the management tables 16, information identifying units (monitoring target units of the monitoring target units) monitored by the units monitored by the plurality of units is registered. In this specification, the information identifying the monitoring target units of the monitoring target units is indicated by “Y”. In the example illustrated in FIG. 3, the second unit 2 monitors the first unit 1, the first unit 1 monitors the fourth unit 4, and information identifying the fourth unit 4 as a monitoring target unit of the monitoring target unit, for example, the ID of the fourth unit 4 is registered in the management table 16 of the second unit 2.

In addition, in the management tables 16, information identifying data destination units of the plurality of units is registered. In this specification, the information identifying the data destination units is indicated by “Z”. In the example illustrated in FIG. 3, the data destination unit of the second unit 2 is the third unit 3, and information identifying the third unit 3, for example, the ID of the third unit 3 is registered in the management table 16 of the second unit 2.

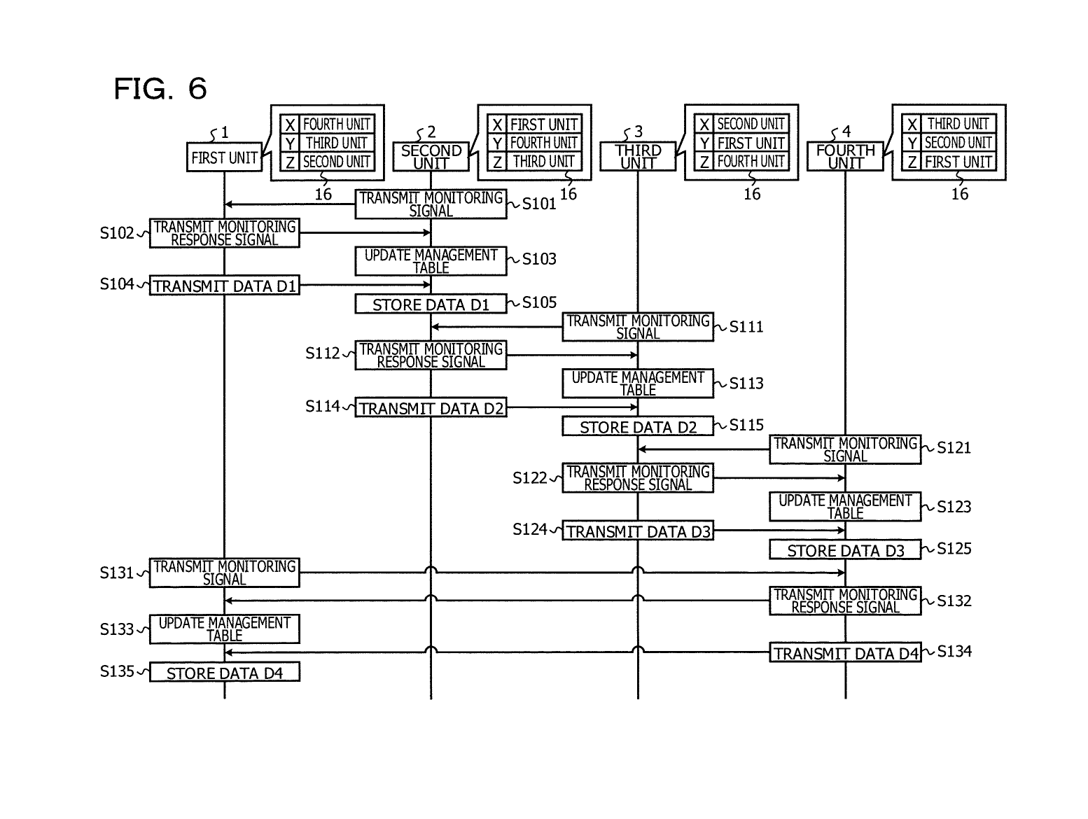

FIG. 6 is a diagram illustrating a process of mutually transmitting and receiving backup data between the plurality of units. As illustrated in FIG. 3, the plurality of units is set to mutually execute the monitoring and the data transmission in the ring. Specifically, in the management table 16 of the first unit 1, information indicating that a monitoring target unit is the fourth unit 4, information indicating that a monitoring target unit of the monitoring target unit is the third unit 3, and information indicating that a data destination unit is the second unit 2, are registered. Similarly, in the management table 16 of the second unit 2, information indicating that a monitoring target unit is the first unit 1, information indicating that a monitoring target unit of the monitoring target unit is the fourth unit 4, and information indicating that a data destination unit is the third unit 3, are registered. In the management table 16 of the third unit 3, information indicating that a monitoring target unit is the second unit 2, information indicating that a monitoring target unit of the monitoring target unit is the first unit 1, and information indicating that a data destination unit is the fourth unit 4, are registered. In the management table 16 of the fourth unit 4, information indicating that a monitoring target unit is the third unit 3, information indicating that a monitoring target unit of the monitoring target unit is the second unit 2, and information indicating that a data destination unit is the first unit 1, are registered. The management tables 16 are initially set by, for example, an administrator of the information processing system 100.

In the state in which the management tables 16 are initially set, pairs of the units monitor the monitoring target units and transmit the data to the data destination units. Since the processes executed by the pairs of the units are common, a monitoring process and a data transmission process (in processes S101 to S105) that are executed by the second unit 2 and the first unit 1 are described below. In process S101, the second unit 2 transmits a monitoring signal to the first unit 1 that is a monitoring target unit. The monitoring signal is a signal to be transmitted by the data destination unit to the monitoring target unit in order to detect that the monitoring target unit has failed. It is assumed that the second unit 2 issues the monitoring signal at predetermined time intervals of, for example, 10 seconds. Additional information included in the monitoring signal is described below.

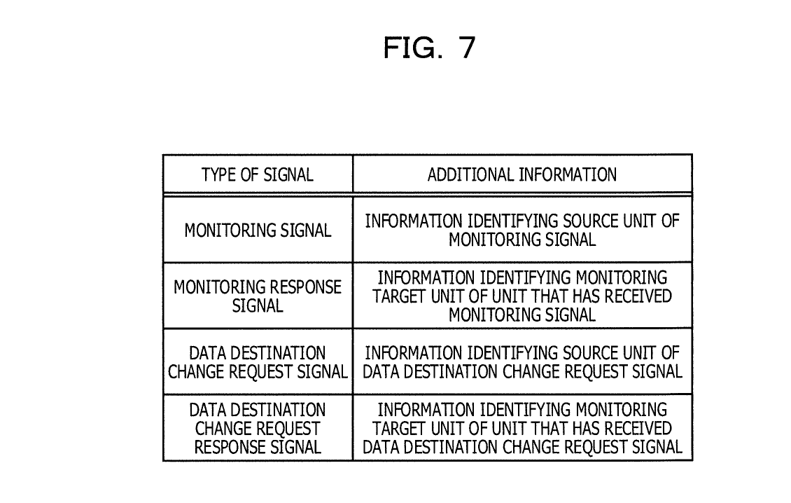

FIG. 7 is a diagram illustrating the types of signals to be transmitted and received between the plurality of units and additional information included in the signals. As illustrated in FIG. 7, the monitoring signal includes, as the additional information, information identifying the unit that has transmitted the monitoring signal. In process S101 illustrated in FIG. 6, information that indicates the second unit 2 that is a source unit of the monitoring signal is included in the monitoring signal.

Return to FIG. 6. In process S102, the first unit 1 transmits, in response to the monitoring signal, a monitoring response signal to the source unit of the monitoring signal. As illustrated in FIG. 7, the monitoring response signal includes, as additional information, information indicating the fourth unit 4 that is a monitoring target unit of the first unit 1. In process S103, the second unit 2 updates the management table 16 based on the additional information included in the received monitoring response signal. Specifically, the additional information included in the monitoring response signal indicates that the monitoring target unit of the first unit 1 is the fourth unit 4, and the second unit 2 updates the information Z of the management table 16 included in the second unit 2 to a content indicating the fourth unit 4. In this example, in the management table 16 of the second unit 2, information indicating that the monitoring target unit of the monitoring target unit is the fourth unit 4 is already registered. Thus, the contents of the management table 16 are not substantially changed by the update process. If the first unit 1 has failed, the monitoring response signal is not transmitted by the first unit 1. Thus, the second unit 2 determines that the second unit 2 does not receive the monitoring response signal even when a predetermined time period elapses after the transmission of the monitoring signal, and the second unit 2 determines that the first unit 1 has failed. A process to be executed when the second unit 2 determines that the first unit 1 has failed is described later.

In process S104, the first unit 1 transmits, to the second unit 2, the data D1 held in the first unit 1 and to be backed up. In process S105, the second unit 2 stores the received data D1 in the volatile memory 30. In this manner, the monitoring of the first unit 1 by the second unit 2 and the process of backing up the data by the second unit 2 are executed. Similarly, the third unit 3 and the second unit 2 execute the monitoring and the data backup process in processes S111 to S115, the fourth unit 4 and the third unit 3 execute the monitoring and the data backup process in processes S121 to S125, and the first unit 1 and the fourth unit 4 execute the monitoring and the data backup process in processes S131 to S135.

Additional information included in a data destination change request signal illustrated in FIG. 7 and additional information included in a data destination change request response signal illustrated in FIG. 7 are described later.

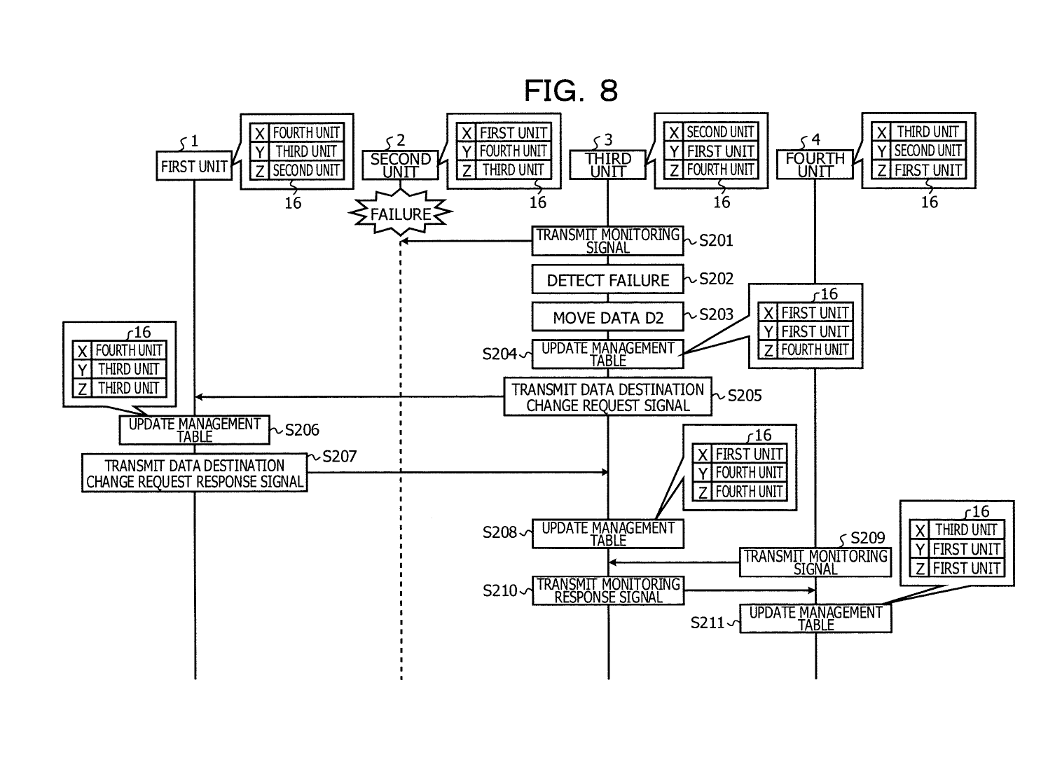

FIG. 8 is a diagram illustrating a process of updating, if any of the plurality of units fails, management tables by the other multiple units. The ring mutual backup system is autonomously changed and newly reconfigured by the process illustrated in FIG. 8 if any of the units included in the information processing system 100 fails.

A case where the second unit 2 fails as illustrated in FIG. 8 is described below. In process S201, the third unit 3 that is a data destination unit of the second unit 2 transmits a monitoring signal to the second unit 2. Since the second unit 2 fails, the second unit 2 is not able to transmit a monitoring response signal in response to the monitoring signal. Thus, the third unit 3 does not receive the monitoring response signal within a predetermined time period after the transmission of the monitoring signal. In process S202, the third unit 3 detects the failure of the second unit 2. In process S203, the third unit 3 moves the data D2, held in the volatile memory 30, of the second unit 2 to the nonvolatile memory 40 by writing the data D2, held in the volatile memory 30, of the second unit 2 in the nonvolatile memory 40 and deleting the data D2 held in the volatile memory 30. In process S204, the third unit 3 updates the information X registered in the management table 16 and identifying the monitoring target unit. This process is executed by writing the information Y registered in the management table 16 over the information X registered in the management table 16. In process S205, the third unit 3 transmits a data destination change request signal to the first unit 1 newly set as a monitoring target unit in the management table 16. The data destination change request signal is a signal to be transmitted by the data destination unit to the new monitoring target unit in order to notify the monitoring target unit that the data destination unit is changed. As illustrated in FIG. 7, the data destination change request signal includes, as additional information, information identifying the data destination unit or information identifying the source unit of the data destination change request signal. In process S206, the first unit 1 that has received the data destination change request signal updates the management table 16 of the first unit 1 based on the additional information included in the data destination change request signal. Specifically, the first unit 1 updates the information Z of the management table 16 to a content indicating the third unit 3 identified by the additional information included in the data destination change request signal. Thus, the first unit 1 may recognize that the new data destination unit is the third unit 3. In process S207, the first unit 1 transmits a data destination change request response signal to the third unit 3. The data destination change request response signal is a signal indicating that the unit that has received the data destination change request signal has updated the management table 16 based on the additional information included in the data destination change request signal. In addition, as illustrated in FIG. 7, the data destination change request response signal includes, as additional information, information identifying a monitoring target unit of the unit. In the example illustrated in FIG. 8, information indicating the fourth unit 4 that is the monitoring target unit of the first unit 1 is included as the additional information in the data destination change request response signal. In process S208, the third unit 3 that has received the data destination change request response signal updates the management table 16 of the third unit 3. Specifically, the third unit 3 registers, as the information Y, information indicating the fourth unit 4 monitored by the first unit 1 in the management table 16.

In this state, the fourth unit 4 does not recognize that the second unit 2 that has previously been a monitoring target unit of the third unit 3 monitored by the fourth unit 4 has been removed from the newly reconfigured backup system. A process of causing the fourth unit 4 to recognize the monitoring target unit of the monitoring target unit in the newly reconfigured backup system is described below. In process S209, the fourth unit 4 transmits a monitoring signal to the third unit 3 that is the monitoring target unit. It is assumed that this monitoring signal is issued at, for example, predetermined time intervals. In process S210, the third unit 3 that has received the monitoring signal from the fourth unit 4 transmits a monitoring response signal to the fourth unit 4. As illustrated in FIG. 7, the monitoring response signal includes, as additional information, information identifying the monitoring target unit of the unit that has issued the monitoring response signal. In process S211, the fourth unit 4 that has received the monitoring response signal updates the information Z of the management table 16 of the fourth unit 4 to a content indicating the first unit 1 based on the additional information included in the monitoring response signal. Specifically, the fourth unit 4 may recognize, based on the additional information included in the monitoring response signal, that the monitoring target unit of the third unit 3 monitored by the fourth unit 4 has been changed from the second unit 2 to the first unit 1. Although not illustrated in FIG. 8, the third unit 3 transmits the data D3 to the fourth unit 4 and the fourth unit 4 stores the data D3 in the volatile memory 30 after process S210. In addition, the first to third units 1 to 3 execute the monitoring and the backup process in the newly reconfigured backup system in accordance with the procedure illustrated in FIG. 6.

In this manner, the units receive information identifying units monitored by monitoring target units from the monitoring target units and updates the management tables 16. Thus, if any of the units included in the information processing system 100 fails, the backup system is newly autonomously reconfigured by the other units excluding the failed unit and the backup process is continuously executed.

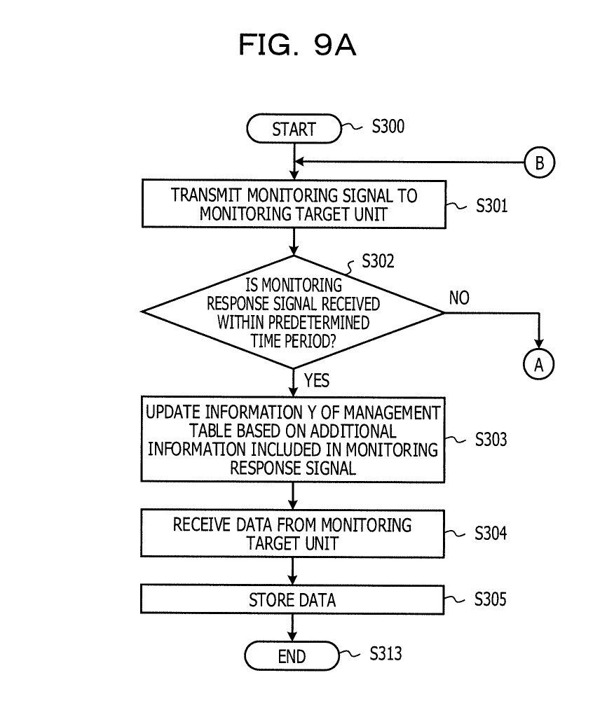

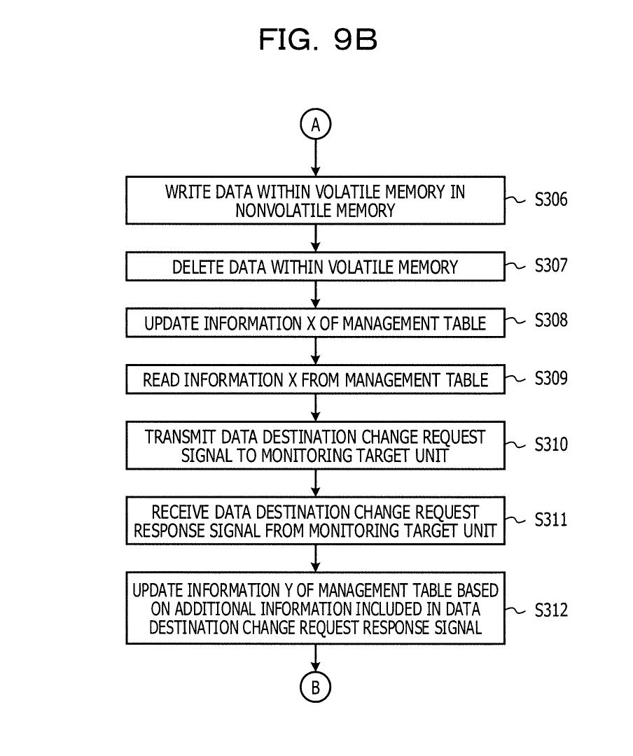

FIG. 9A is a flowchart of a process that is executed by the processor 10 of the third unit 3 in the example illustrated in FIG. 6 and is mainly related to the monitoring of the second unit 2. The process is started by the processor 10 in process S300. In process S301, the monitoring section 12 transmits a monitoring signal to the second unit 2 that is a monitoring target unit. In process S302, the monitoring section 12 determines whether or not the monitoring section 12 has received a monitoring response signal within a predetermined time period after the transmission of the monitoring signal. The predetermined time period is, for example, 30 seconds. If the monitoring section 12 determines that the monitoring section 12 has received the monitoring response signal within the predetermined time period, the process flow proceeds to process S303. If the monitoring section 12 determines that the monitoring section 12 has not received the monitoring response signal within the predetermined time period, the process flow proceeds to process S306 illustrated in FIG. 9B. In process S303, the management table updating section 14 updates the information Y of the management table 16 based on additional information included in the monitoring response signal. In process S304, the data transceiver 11 receives the data D2 from the second unit 2 that is the monitoring target unit. In process S305, the memory controller 15 stores the data D2 received by the data transceiver 11 in the volatile memory 30. After process S305, the process flow is terminated in process S313.

FIG. 9B is a flowchart of a process that is executed by the processor 10 of the third unit 3 in the example illustrated in FIG. 8 upon the detection of a failure of the second unit 2. The process flow to be executed when the monitoring section 12 determines that the monitoring section 12 has not received the monitoring response signal within the predetermined time period in process S302 is described below with reference to FIG. 9B. In process S306, the memory controller 15 writes the data D2 held in the volatile memory 30 in the nonvolatile memory 40. In process S307, the memory controller 15 deletes the data D2 held in the volatile memory 30. In process S308, the management table updating section 14 updates the information X of the management table 16 by changing the information X to the information Y of the management table 16. In process S309, the controller 13 reads the updated information X from the management table 16. In process S310, the controller 13 transmits a data destination change request signal to a new monitoring target unit identified by the information X of the management table 16 or to the first unit 1 in the example illustrated in FIG. 8. In process S311, the controller 13 receives a data destination change request response signal from the monitoring target unit. In process S312, the management table updating section 14 updates the information Y of the management table 16 based on additional information included in the data destination change request response signal. Then, the process flow returns to process S301 and the monitoring section 12 transmits a monitoring signal to the new monitoring target unit updated in process S308 and executes the process of backing up the data of the new monitoring target unit.

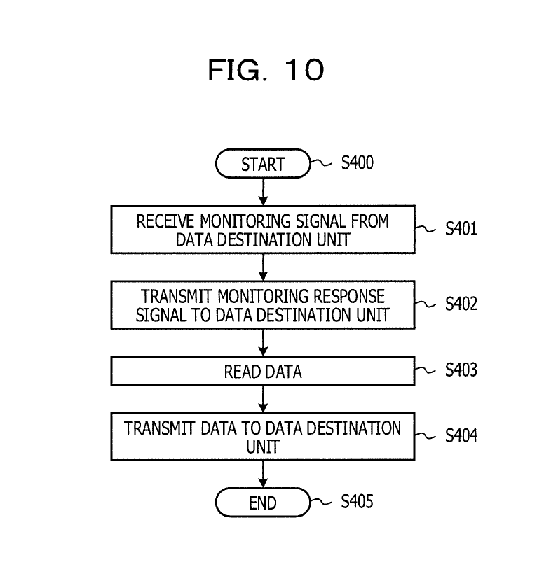

FIG. 10 is a flowchart of a process that is executed by the processor 10 of the second unit 2 in the example illustrated in FIG. 6 and is mainly related to the transmission of a monitoring response signal and the data D2. The process is started by the processor 10 in process S400. In process S401, the monitoring section 12 receives a monitoring signal from the data destination unit. In process S402, the monitoring section 12 transmits a monitoring response signal to the data destination nit. In process S403, the memory controller 15 reads, as backup data, the data D2 held in the volatile memory 30. In process S404, the data transceiver 11 transmits the read data D2 to the data destination unit. Then, in process S405, the process flow is terminated.

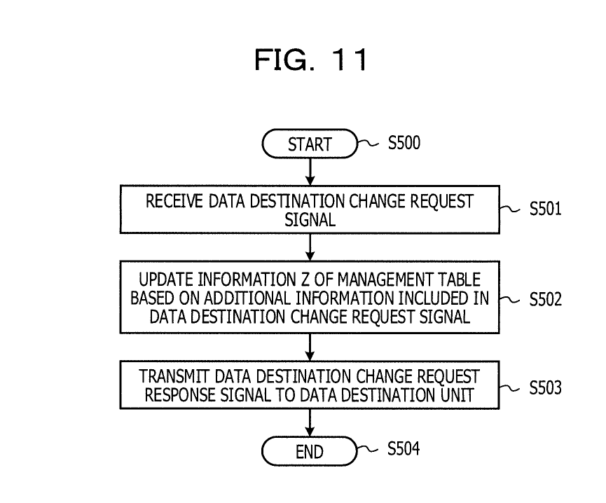

FIG. 11 is a flowchart of a process that is executed by the processor 10 of the first unit 1 in the example illustrated in FIG. 8 and is mainly related to a change in the management table 16. The process is started by the processor 10 in process S500. In process S501, the controller 13 receives the data destination change request signal from the third unit 3. In process S502, the management table updating section 14 updates, based on additional information included in the data destination change request signal, the information Z of the management table 16 to a content indicating the third unit 3 that is a new data destination unit. In process S503, the controller 13 transmits a data destination change request response signal to the new data destination unit. Then, the process flow is terminated in process S504.

In this manner, the units notify data destination units of the information X identifying monitoring target units monitored by the units. Thus, the units may identify units monitored by the monitoring target units monitored by the units. If a certain monitoring target unit of a certain unit fails, the certain unit may register, as a new monitoring target unit, a monitoring target unit of the certain monitoring target unit. Thus, even if any of the units included in the information processing system 100 fails, the other multiple units may newly autonomously reconfigure the backup system.

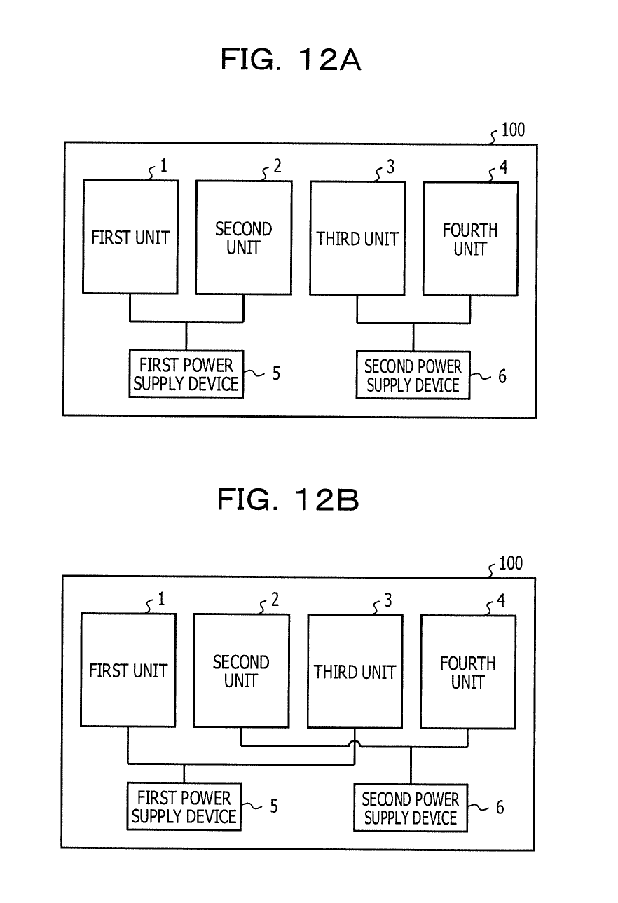

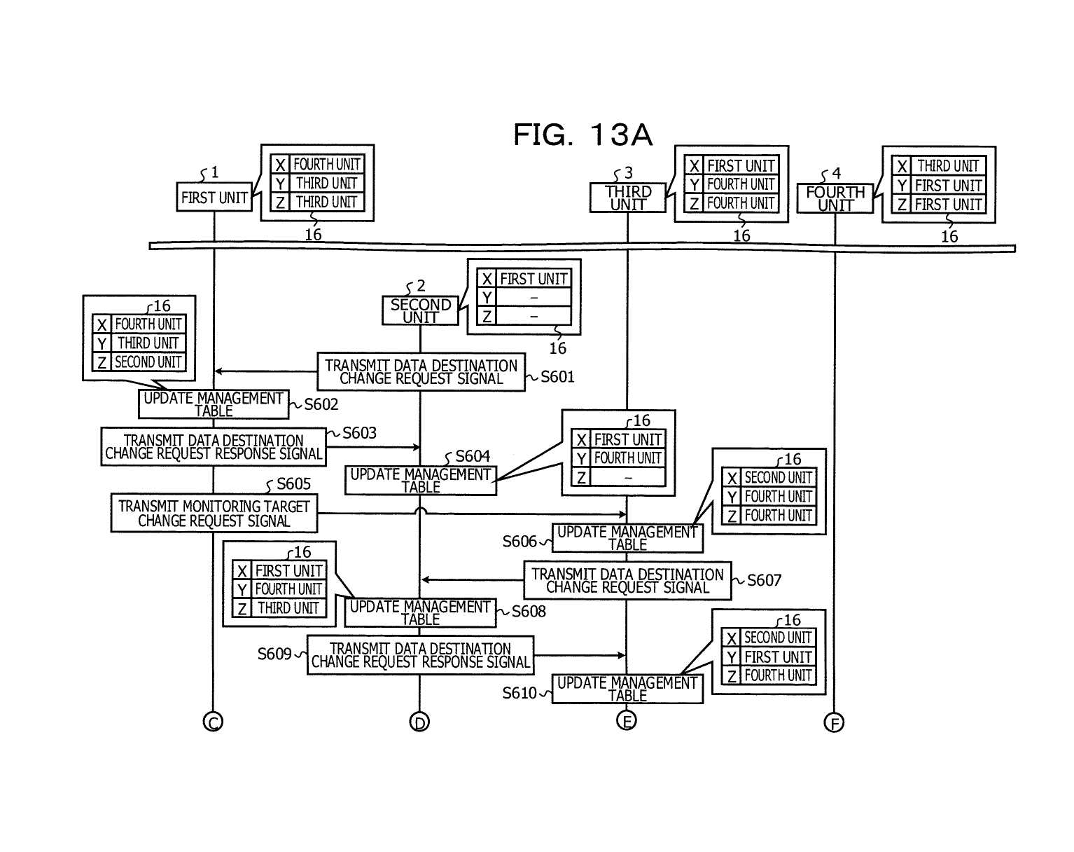

FIGS. 12A and 12B are diagrams illustrating coupling relationships between the plurality of units and power supply devices. In FIG. 12A, a first power supply device 5 and a second power supply device 6 that are independent of each other are included in the information processing system 100. The first power supply device 5 supplies power to the first unit 1 and the second unit 2, while the second power supply device 6 supplies power to the third unit 3 and the fourth unit 4. In this case, if the first power supply device 5 fails, the first unit 1 and the second unit 2 do not receive the supply of power from the first power supply device 5. The second unit 2 that does not appropriately receive the supply of power is not able to issue a monitoring response signal in response to a monitoring signal transmitted from the third unit 3 that is a data destination unit. Thus, the third unit 3 determines that the second unit 2 has failed. Then, the third unit 3 transmits a data destination change request signal to the first unit 1 that is a monitoring target unit of the second unit 2. However, the first unit 1 is not able to execute an appropriate process due to the failure of the first power supply device 5, and the backup system may not be newly reconfigured. Specifically, if both two adjacent units fail, the failures may not be handled by the method of causing each unit to recognize a monitoring target unit of a monitoring target unit. In order to avoid causing two adjacent units to fail due to a failure of a power supply device, the coupling relationships, illustrated in FIG. 12B, between the power supply devices and the units are desirable. In FIG. 12B, the first unit 1 and the third unit 3 are coupled to the first power supply device 5, and the second unit 2 and the fourth unit 4 are coupled to the second power supply device 6. In these correspondence relationships between the power supply devices and the units, even if the first power supply device 5 fails, a state in which both two adjacent units fail may be avoided.

The method in which even if any of the plurality of units included in the information processing system 100 fails, the remaining units newly autonomously reconfigure the backup system is described above.

In the aforementioned embodiment, if a unit fails or is removed, the backup system is reconfigured based on the fact that a monitoring response signal is not transmitted from the unit. As a modified example, if a unit that has received a monitoring signal does not fail and does not transmit a monitoring response signal to a data destination unit, the backup system may be reconfigured. For example, if the load of the processor 10 of the unit that has received the monitoring signal is high and it is determined that the unit is not able to transmit data or does not transmit data to avoid an increase in the load of the processor 10, the unit does not transmit the monitoring response signal. As a result, the data destination unit does not receive the monitoring response signal and the backup system is reconfigured in the same manner as the aforementioned embodiment.

As another modified example, a unit that has received a monitoring signal may generate a monitoring response signal including information indicating that the unit does not transmit data. For example, if the load of the processor 10 of the unit that has received the monitoring signal is high or the like, like the aforementioned modified example, the unit generates a monitoring response signal including information indicating that the unit does not transmit data. This monitoring response signal is transmitted to a data destination unit. Then, the data destination unit that has received the monitoring response signal executes the procedure that is to be executed when a failure of a monitoring target unit is detected, and the backup system is reconfigured. In this manner, the embodiment may be applied to a case where a unit that has received a monitoring signal does not fail.

Next, a method of newly reconfiguring the backup system when a new unit is added to the information processing system 100 including a plurality of units having the ring backup system is described.

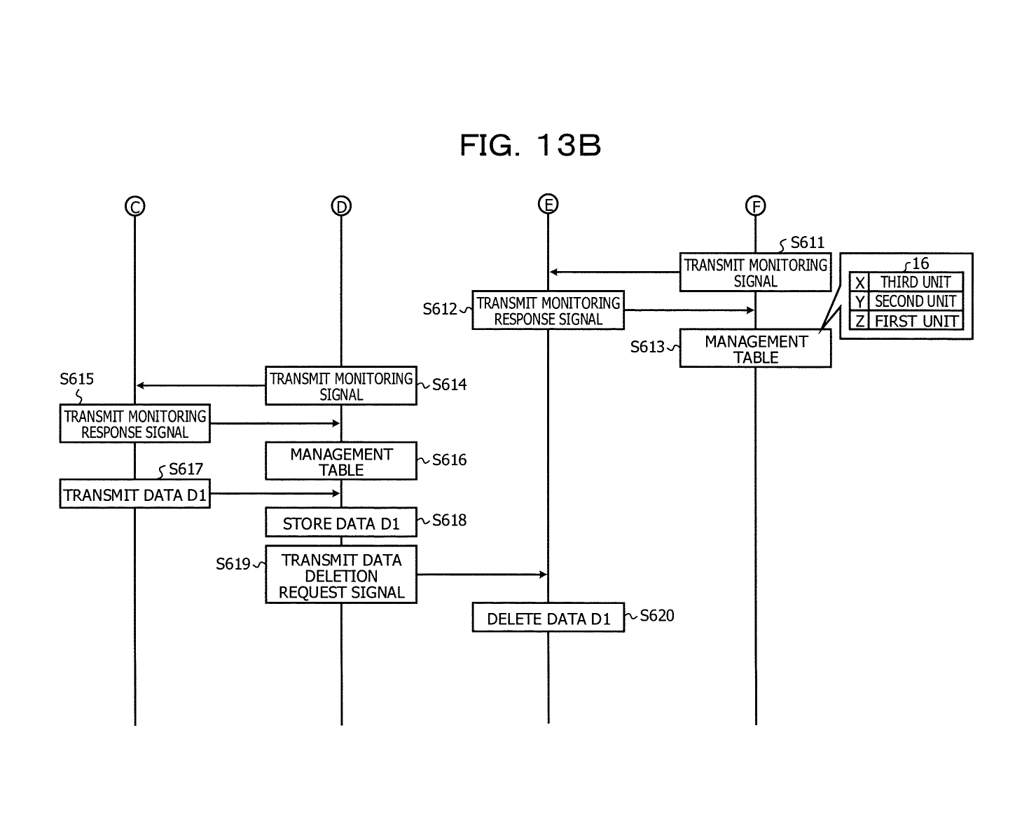

FIGS. 13A and 13B are diagrams illustrating a process of updating management tables 16 by a plurality of units when a new unit is added. In FIG. 13A, the first unit 1, the third unit 3, and the fourth unit 4 execute the mutual backup process in the ring. Specifically, the first unit 1 monitors the fourth unit 4, the fourth unit 4 transmits the data D4 to the first unit 1, the third unit 3 monitors the first unit 1, the first unit 1 transmits the data D1 to the third unit 3, the fourth unit 4 monitors the third unit 3, and the third unit 3 transmits the data D3 to the fourth unit 4. It is assumed that, in this state, the second unit 2 is newly added to the information processing system 100. When the second unit 2 is added to the information processing system 100, the administrator of the information processing system 100 determines a monitoring target unit of the second unit 2. In the example illustrated in FIG. 13A, the monitoring target unit of the second unit 2 is determined to be the first unit 1. Then, a content indicating the first unit 1 is registered as the information X in the management table 16 of the second unit 2. It is assumed that, at this time, the information Y and information Z of the management table of the second unit 2 have yet to be determined. Then, in process S601, the second unit 2 transmits a data destination change request signal to the first unit 1 that is the monitoring target unit. In process S602, the first unit 1 that has received the data destination change request signal from the second unit 2 updates the management table 16 based on additional information included in the data destination change request signal. As a result, the information Z of the management table 16 of the first unit 1 is rewritten from a content indicating the third unit 3 to a content indicating the second unit 2. Then, in process S603, the first unit 1 transmits a data destination change request response signal to the second unit 2 registered as a new data destination unit. In process S604, the second unit 2 that has received the data destination change request response signal updates the information Y of the management table 16 based on additional information included in the data destination change request response signal. Thus, the second unit 2 may recognize that a monitoring target unit of the first unit 1, which is the monitoring target unit of the second unit 2, is the fourth unit 4.

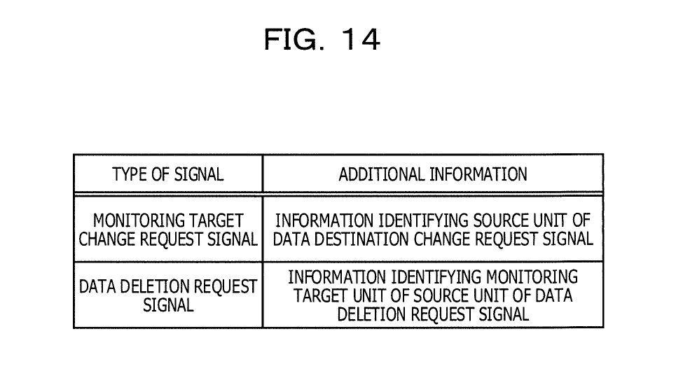

Next, in process S605, the first unit 1 transmits a monitoring target change request signal to the third unit 3 that is a previous data destination unit. The monitoring target change request signal is a signal that enables the unit that has received the data destination change request signal to notify the previous data destination unit that the new data destination unit has been set. Additional information included in the monitoring target change request signal is described below with reference to FIG. 14.

FIG. 14 is a diagram illustrating the types of signals to be transmitted and received between the plurality of units and additional information included in the signals. A monitoring target change request signal includes, as additional information, information identifying a source unit of a data destination change request signal. In the example illustrated in FIG. 13A, the monitoring change request signal transmitted from the first unit 1 to the third unit 3 includes information indicating the second unit 2 that is the new data destination unit of the first unit 1. Return to the description of FIG. 13A. In process S606, the third unit 3 that has received the monitoring target change request signal updates the information X of the management table 16 based on the additional information included in the monitoring target change request signal. Thus, the monitoring target unit of the third unit 3 is changed from the first unit 1 to the newly added second unit 2. In process S607, the third unit 3 transmits a data destination change request signal to the second unit 2 that is the new monitoring target unit. In process S608, the second unit 2 that has received the data destination change request signal updates the information Z of the management table 16 based on additional information included in the data destination change request signal and recognizes the data destination unit of the second unit 2. Then, in process S609, the second unit 2 transmits a data destination change request response signal to the third unit 3 that is the data destination unit. In process S610, the third unit 3 updates the information Y of the management 16 based on additional information included in the data destination change request response signal.

Subsequently, the process illustrated in FIG. 13B is described. In process S611, the fourth unit 4 transmits a monitoring signal to the third unit 3 that is a monitoring target unit. In process S612, the third unit 3 that has received the monitoring signal transmits a monitoring response signal to the fourth unit 4. In process S613, the fourth unit 4 that has received the monitoring response signal updates the information Y of the management table 16 based on additional information included in the monitoring response signal. Thus, information indicating that a monitoring target unit of the monitoring target unit of the fourth unit 4 is the newly added second unit 2 is registered in the management table 16 of the fourth unit 4. Although not illustrated in FIG. 13B, the third unit 3 transmits the data D3 to the fourth unit 4 after process S612. In addition, the first unit 1, the second unit 2, and the third unit 3 periodically execute the monitoring and the backup process on the fourth unit 4, the first unit 1, and the second unit 2, respectively.

A process of deleting data already backed up is described below. Before the second unit 2 is added to the information processing system 100, the third unit 3 is the data destination unit of the first unit 1 and the data D1 of the first unit 1 is backed up by the third unit 3. However, after the second unit 2 is added, the data D1 of the first unit 1 is backed up by the second unit 2. Thus, the same data D1 is held in the multiple units. In order to avoid this situation, the data D1 of the first unit 1 stored in the third unit 3 is deleted in processes S614 to S620 illustrated in FIG. 13B. First, in process S614, the newly added second unit 2 transmits a monitoring signal to the first unit 1. In process S615, the first unit 1 transmits a monitoring response signal to the second unit 2. In process S616, the second unit 2 updates the management table 16. In process S617, the first unit 1 transmits the data D1 to the second unit 2. In process S618, the second unit that has received the data D1 stores the data D1 in the volatile memory 30. After that, in process S619, the second unit 2 transmits a data deletion request signal to the third unit 3. The data deletion request signal is a signal to instruct the unit, which has previously received and stored the data, to delete the data when the newly added unit receives the data. As illustrated in FIG. 14, the data deletion request signal includes, as additional information, information identifying the monitoring target unit of the source unit of the data deletion request signal. In the embodiment, a content indicating the first unit 1 is notified as additional information to the third unit 3. In process S620, the third unit 3 that has received the data deletion request signal executes a process of deleting the held data D1 previously received from the first unit 1 identified by the additional information. Thus, a pointless reduction, caused by the holding of the same data by multiple units, in an entire available memory capacity of the information processing system 100 is suppressed.

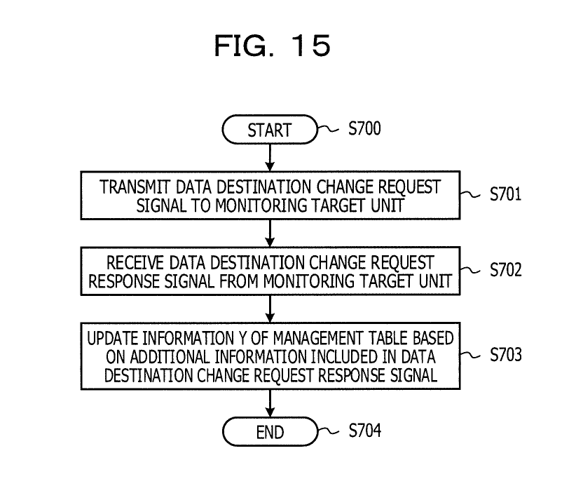

FIG. 15 is a flowchart of a process that is executed by the processor 10 of the second unit 2 in the example illustrated in FIGS. 13A and 13B and is mainly related to the transmission of the data destination change request signal. The process flow is started by the processor 10 in process S700. In process S701, the controller 13 transmits the data destination change request signal to the first unit 1 that is a monitoring target unit. In process S702, the controller 13 receives the data destination change request response signal from the first unit 1 that is the monitoring target unit. In process S703, the management table updating section 14 updates the information Y of the management table 16 based on the additional information included in the data destination change request response signal. Thus, the second unit 2 may identify the monitoring target unit of the first unit 1, which is the monitoring target unit of the second unit 2. Then, in process S704, the process flow is terminated.

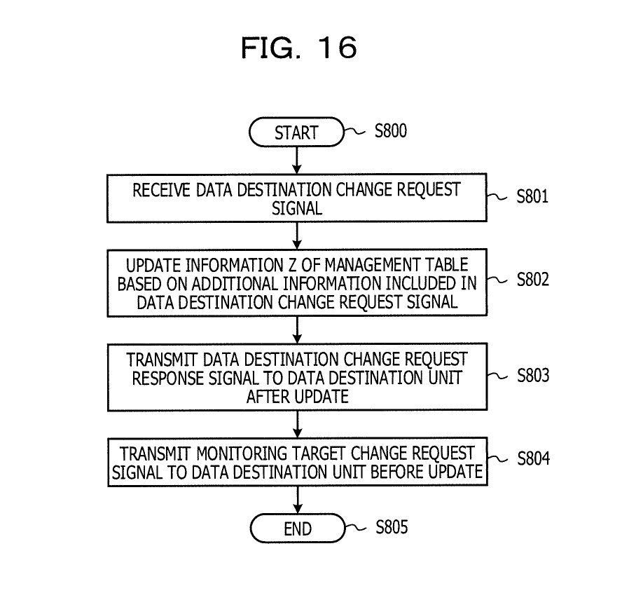

FIG. 16 is a flowchart of a process that is executed by the processor 10 of the first unit 1 in the example illustrated in FIGS. 13A and 13B and is mainly related to the reception of the data destination change request signal. The process flow is started by the processor 10 in process S800. In process S801, the controller 13 receives the data destination unit change request signal from the newly added second unit 2. In process S802, the management table updating section 14 updates the information Z of the management table 16 based on the additional information included in the received data destination change request signal. Thus, the first unit 1 recognizes that the newly added second unit 2 becomes a new data destination unit of the first unit 1. In process S803, the controller 13 transmits the data destination change request response signal to the second unit 2 that is the data destination unit identified in the management table 16 after the update. In process S804, the controller 13 transmits the monitoring target change request signal to the third unit 3 that is the data destination unit identified in the management table 16 before the update. Then, in process S805, the process flow is terminated.

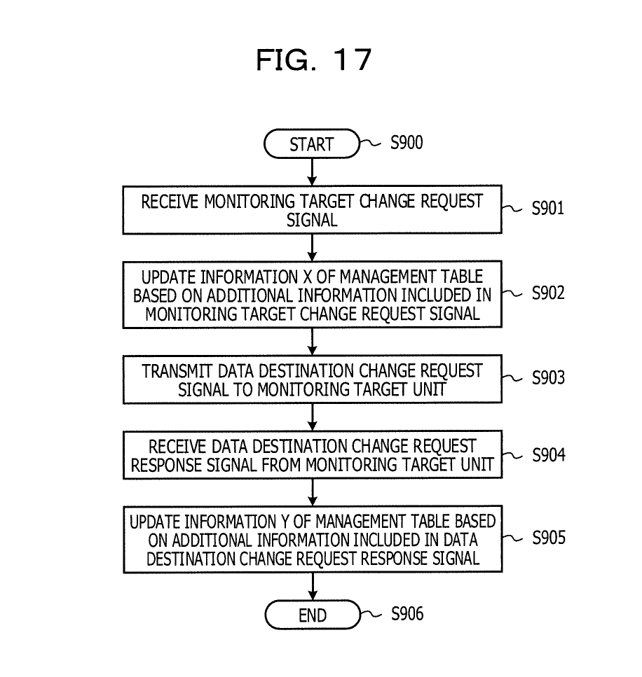

FIG. 17 is a flowchart of a process that is executed by the processor 10 of the third unit 3 in the example illustrated in FIGS. 13A and 13B and is mainly related to the transmission of the data destination change request signal. The process flow is started by the processor 10 in process S900. In process S901, the controller 13 receives the monitoring target change request signal from the first unit 1. In process S902, the management table updating section 14 updates the information X of the management table 16 based on the additional information included in the monitoring target change request signal. Thus, the third unit 3 recognizes that the newly added second unit 2 becomes a new monitoring target unit. In process S903, the controller 13 transmits the data destination request signal to the second unit 2 that is the monitoring target unit. In process S904, the controller 13 receives the data destination change request response signal from the second unit 2 that is the monitoring target unit. In process S905, the management table updating section 14 updates the information Y of the management table 16 based on the additional information included in the data destination change request response signal. Then, in process S906, the process flow is terminated.

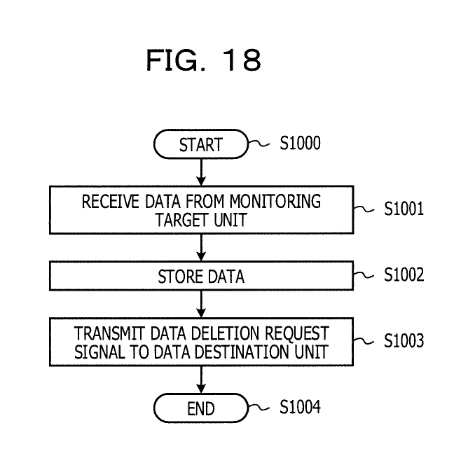

FIG. 18 is a flowchart of a process that is executed by the processor 10 of the second unit 2 in the example illustrated in FIGS. 13A and 13B and is mainly related to the transmission of the data deletion request signal. The process flow is started by the processor 10 in process S1000. In process S1001, the controller 13 receives the data D1 from the first unit 1 that is a monitoring target unit. In process S1002, the memory controller 15 stores the received data D1 in the volatile memory 30. In process S1003, the controller 13 transmits the data deletion request signal to the third unit 3 that is a data destination unit and the controller 13 requests the third unit 3 to delete the data D1 already received from the first unit 1. Then, in process S1004, the process flow is terminated.

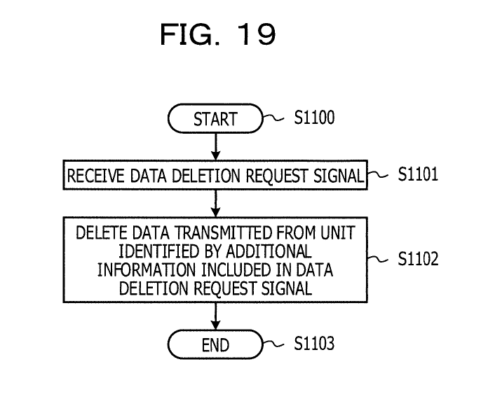

FIG. 19 is a flowchart of a process that is executed by the processor 10 of the third unit 3 in the example illustrated in FIGS. 13A and 13B and is mainly related to the data deletion. The process flow is started by the processor 10 in process S1100. In process S1101, the controller 13 receives the data deletion request signal. In process S1102, the controller 15 deletes, from the volatile memory 30, the data D1 of the unit identified by additional information included in the data deletion request signal. Then, in process S1103, the process flow is terminated.

The method of autonomously reconfiguring the ring backup system by a plurality of units including a newly added unit upon the addition of the new unit to the information processing system 100 is described above. In the information processing system 100 that does not include a managing unit for managing the entire multiple units, even when the number of units increases, the monitoring process and the data backup process are autonomously continued.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A method of data backup using an information processing system including a first information processing device, a second information processing device configured to back up first data of the first information processing device, and a third information processing device configured to back up second data of the second information processing device, the method comprising:
storing, by the third information processing device, first information indicating that the second information processing device backs up the first data of the first information processing device;
transmitting, from the third information processing device to the second information processing device, a first signal; and
backing up, by the third information processing device, the first data of the first information processing device based on the first information when the third information processing device does not receive, from the second information processing device, a first response signal that is a response to the first signal and indicates that the second information processing device transmits the second data to the third information processing device.

2. The method according to claim 1, further comprising:
transmitting, by the third information processing device, a second signal to the second information processing device before the transmitting of the first signal;
transmitting, by the second information processing device, a second response signal that is a response to the second signal and includes the first information and indicates that the second information processing device transmits the second data to the third information processing device; and
storing, by the third information processing device, the first information included in the second response signal.

3. The method according to claim 2, further comprising:
when the second information processing device transmits the second response signal, transmitting, by second information processing device, the second data to the third information processing device; and
storing, by the third information processing device, the second data.

4. The method according to claim 1, further comprising:
storing, by the first information processing device, second information indicating a destination device of the first data;
transmitting, by the third information processing device, a first request to change a content of the second information from a content indicating the second information processing device as the destination device to a content indicating the third information processing device as the destination device when the third information processing device does not receive the first response signal; and
changing, by the first information processing device, based on the first request, the content of the second information from the content indicating the second information processing device as the destination device to the content indicating the third information processing device as the destination device.

5. The method according to claim 3, wherein
the third information processing device includes a volatile memory and a nonvolatile memory,
in the storing of the second data by the third information processing device, the second data is stored in the volatile memory, and
in the backing up of the first data by the third information processing device, the second data is moved from the volatile memory to the nonvolatile memory and the first data is stored in the volatile memory.

6. The method according to claim 1, wherein
the information processing system includes a plurality of information processing devices including the first information processing device, the second information processing device, and the third information processing device, and
each of the plurality of information processing devices backs up data of another information processing device among the plurality of information processing devices in a ring manner.

7. The method according to claim 1, wherein
the first information processing device includes a memory and a processor coupled to the memory, and
the first data is stored in the memory and includes at least one of a computer program to be executed by the processor, data to be used for arithmetic processing by the processor, data that is the result of the arithmetic processing by the processor, and log data indicating a history record of the arithmetic processing by the processor.

8. The method according to claim 6, wherein
each of the plurality of information processing devices includes a memory and a processor coupled to the memory, and
each of the plurality of information processing devices is able to be inserted to the information processing system the and to be removed from the information processing system.

9. A method of data backup using an information processing system including a first information processing device and a third information processing device configured to back up first data of the first information processing device, the method comprising:
when a second information processing device configured to back up the first data of the first information processing device is added to the information processing system, transmitting, from the second information processing device to the first information processing device, a first request to change a destination of the first data from the third information processing device to the second information processing device;
transmitting, from the first information processing device to the second information processing device, the first data based on the first request;
storing, by the second information processing device, the first data;
transmitting, from the first information processing device to the third information processing device, a second request to back up second data of the second information processing device;
transmitting, from the third information processing device to the second information processing device, based on the second request, a third request to set a destination of the second data to the third information processing device;
transmitting, from the second information processing device to the third information processing device, based on the third request, the second data; and
storing, by the third information processing device, the second data.

10. The method according to claim 9, further comprising:
storing, by the first information processing device, first information identifying a destination device of the first data;
changing, by the first information processing device, based on the first request, a content of the first information from a content indicating the third information processing device as the destination device to a content indicating the second information processing device as the destination device; and
transmitting, from the first information processing device to the second information processing device, the first data based on the changed first information.

11. The method according to claim 9, further comprising:
transmitting, from the first information processing device to the second information processing device, a first response signal that is a response to the first request,
wherein the first response signal includes second information indicating that the first information processing device backs up fourth data of a fourth information processing device included in the information processing system.

12. The method according to claim 9, further comprising:
after the transmitting of the first data from the first information processing device to the second information processing device, transmitting, from the second information processing device to the third information processing device, a fourth request to delete the first data stored in the third information processing device; and
deleting, by the third information processing device, the first data stored in the third information processing device.

13. An information processing system comprising:
a first information processing device including a first memory and a first processor coupled to the first memory;
a second information processing device including a second memory and a second processor coupled to the second memory and configured to back up first data of the first information processing device; and
a third information processing device including a third memory and a third processor coupled to the third memory and configured to back up second data of the second information processing device, wherein
the third processor is configured to store first information indicating that the second information processing device backs up the first data of the first information processing device,
the third processor is configured to transmit, to the second information processing device, a first signal, and
the third processor is configured to back up the first data of the first information processing device based on the first information when the third information processing device does not receive, from the second information processing device, a first response signal that is a response to the first signal and indicates that the second information processing device transmits the second data to the third information processing device.

14. The information processing system according to claim 13, wherein
the third processor is configured to transmit a second signal to the second information processing device before transmitting the first signal,
the second processor is configured to transmit a second response signal that is a response to the second signal and includes the first information and indicates that the second information processing device transmits the second data to the third information processing device, and
the third processor is configured to store the first information included in the second response signal.

15. The information processing system according to claim 14, wherein
when the second processor transmits the second response signal, the second processor is configured to transmit the second data to the third information processing device, and
the third processor is configured to store the second data.

16. The information processing system according to claim 13, wherein
the first processor is configured to store second information indicating a destination device of the first data,
the third processor is configured to transmit a first request to change a content of the second information from a content indicating the second information processing device as the destination device to a content indicating the third information processing device as the destination device when the third information processing device does not receive the first response signal, and
the first processor is configured to change, based on the first request, the content of the second information from the content indicating the second information processing device as the destination device to the content indicating the third information processing device as the destination device.

17. The information processing system according to claim 15, wherein the third memory includes a volatile memory and a nonvolatile memory, the third processor is configured to:
store the second data in the volatile memory,
move the second data from the volatile memory to the nonvolatile memory, and
store the first data in the volatile memory.

18. The information processing system according to claim 13, wherein
the information processing system includes a plurality of information processing devices including the first information processing device, the second information processing device, and the third information processing device, and
each of the plurality of information processing devices is configured to back up data of another information processing device among the plurality of information processing devices in a ring manner.

19. The information processing system according to claim 13, wherein
the first data is stored in the first memory and includes at least one of a computer program to be executed by the processor, data to be used for arithmetic processing by the processor, data that is the result of the arithmetic processing by the processor, and log data indicating a history record of the arithmetic processing by the processor.

20. The information processing system according to claim 18, wherein
each of the plurality of information processing devices is able to be inserted to the information processing system the and to be removed from the information processing system.
